(19) United States
(12) Patent Application Publication
(10) Pub. No.: US 2024/0126240 A1
(43) Pub. Date: Apr. 18, 2024

(54) NUMERICAL CONTROLLER AND COMPUTER READABLE STORAGE MEDIUM

(71) Applicant: Fanuc Corporation, Minamitsuru-gun, Yamanashi (JP)

(72) Inventor: Kousuke Uno, Minamitsuru-gun, Yamanashi (JP)

(73) Assignee: Fanuc Corporation, Minamitsuru-gun, Yamanashi (JP)

(21) Appl. No.: 18/276,735

(22) PCT Filed: Feb. 28, 2022
(86) PCT No.: PCT/JP2022/008301

§ 371 Date: Aug. 10, 2023

(30) Foreign Application Priority Data
Mar. 2, 2021 (JP) 2021-032850

(51) Int. Cl. G05B 19/4155

(52) U.S. Cl. CPC G05B 19/4155; G05B 2219/49108

(57) ABSTRACT

A numerical controller includes: a spindle load detection unit that detects time-series data on a load on a spindle when a workpiece is machined; a machining time setting unit that sets a machining time taken in machining the workpiece; a spindle load calculation unit that, based on the time-series data, calculates a load on the spindle applied when the workpiece is machined in the machining time set by the machining time setting unit and when a feed rate of the spindle is controlled so that the load on the spindle is a constant load; and a spindle load output unit that outputs data indicating the load on the spindle calculated by the spindle load calculation unit.

### CROSS REFERENCE TO RELATED APPLICATIONS

This is the U.S. National Phase application of PCT/JP2022/008301, filed Feb. 28, 2022, which claims priority to Japanese Patent Application No. 2021-032850, filed Mar. 2, 2021, the disclosures of each of these applications being incorporated herein by reference in their entireties for all purposes.

### FIELD OF THE INVENTION

The present disclosure relates to a numerical control device that controls a machine tool and to a computer readable storage medium.

### BACKGROUND OF THE INVENTION

In machine tools, a technology to control the feed rate of a spindle so that the load on the spindle remains constant is known (for example, Patent Literature 1). Such control can extend the lifetime of a tool.

### PATENT LITERATURE

Patent Literature 1: Japanese Patent Application Laid-Open No. 2019-117458

### SUMMARY OF THE INVENTION

When controlling the feed rate of a spindle so that the load on the spindle remains constant, however, it is difficult to predict a machining time, because the feed rate changes in accordance with the load. Thus, to complete machining of a workpiece in a desired machining time, it is necessary to perform test machining many times with adjustment of the load on the spindle.

The present disclosure intends to provide a numerical controller that, when the feed rate of a spindle is controlled so that the load on the spindle remains constant, makes it possible to set a machining time for a workpiece to a desired time and also intends to provide a computer readable storage medium.

A numerical controller includes: a spindle load detection unit that detects time-series data on a load on a spindle when a workpiece is machined; a machining time setting unit that sets a machining time taken in machining the workpiece; a spindle load calculation unit that, based on the time-series data, calculates a load on the spindle applied when the workpiece is machined in the machining time set by the machining time setting unit and when a feed rate of the spindle is controlled so that the load on the spindle is a constant load; and a spindle load output unit that outputs data indicating the load on the spindle calculated by the spindle load calculation unit.

A computer readable storage medium stores an instruction that causes a computer to perform: detecting time-series data on a load on a spindle when a workpiece is machined; setting a machining time taken in machining the workpiece; based on the time-series data, calculating a load on the spindle applied when the workpiece is machined in the set machining time and when a feed rate of the spindle is controlled so that the load on the spindle is a constant load; and outputting data indicating the calculated load on the spindle.

According to the present disclosure, when the feed rate of a spindle is controlled so that the load on the spindle remains constant, it is possible to set a machining time for a workpiece to a desired time.

### BRIEF DESCRIPTION OF DRAWINGS

FIG. 1 is a diagram illustrating an example of a hardware configuration of a machine tool.

FIG. 2 is a block diagram illustrating an example of functions of a numerical controller.

FIG. 3 is a diagram illustrating an example of time-series data stored in a spindle load storage unit.

FIG. 4A is a diagram illustrating a method of calculating a load on a spindle performed by a spindle load calculation unit.

FIG. 4B is a diagram illustrating a method of calculating a load on a spindle performed by the spindle load calculation unit.

FIG. 5 is a diagram illustrating a method of calculating a load on a spindle performed by the spindle load calculation unit.

FIG. 6 is a flowchart illustrating an example of a flow of a process performed by the numerical controller.

FIG. 7 is a diagram illustrating an example of the spindle load calculation unit.

FIG. 8 is a diagram illustrating a display example of a load on the spindle displayed on an input/output device.

FIG. 9 is a block diagram illustrating an example of functions of the numerical controller.

FIG. 10 is a diagram illustrating an example of time-series data on a load on the spindle.

FIG. 11 is a diagram illustrating an example of a frequency distribution.

### DETAILED DESCRIPTION OF EMBODIMENTS OF THE INVENTION

One embodiment of the present disclosure will be described below with reference to the drawings. Note that not all of the combined features described in the following embodiment are necessarily required for solving the problem. Further, detailed description than is needed may be omitted. Further, the description and the drawings of the following embodiment are provided for those skilled in the art to fully understand the present disclosure and are not intended to limit the claims.

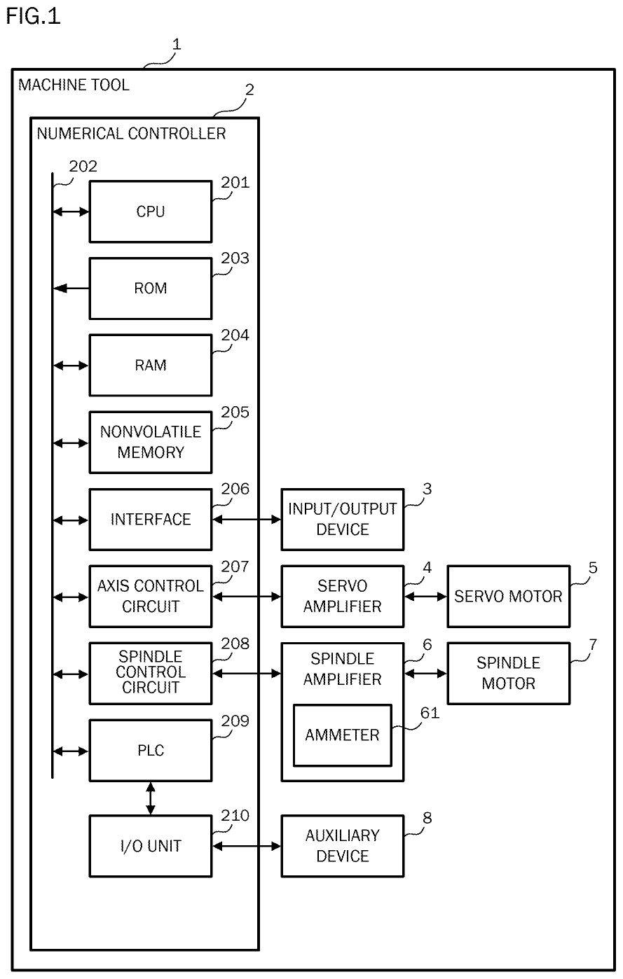

FIG. 1 is a diagram illustrating an example of a hardware configuration of a machine tool. The machine tool 1 is, for example, a lathe, a machining center, or a multi-tasking machine.

The machine tool 1 has a numerical controller 2, an input/output device 3, a servo amplifier 4 and a servo motor 5, a spindle amplifier 6 and a spindle motor 7, and an auxiliary device 8, for example.

The numerical controller 2 is a device that controls the overall machine tool 1. The numerical controller 2 has a central processing unit (CPU) 201, a bus 202, a read-only memory (ROM) 203, a random-access memory (RAM) 204, and a nonvolatile memory 205.

The CPU 201 is a processor that controls the overall numerical controller 2 in accordance with a system program. The CPU 201 reads a system program or the like stored in the ROM 203 via the bus 202. Further, the CPU 201 controls the servo motor 5 and the spindle motor 7 in accordance with a machining program.

The CPU 201 performs, for example, analysis of a machining program and output of a control command to the servo motor 5 in each control cycle.

The bus 202 is a communication path connecting respective hardware components in the numerical controller 2 to each other. Respective hardware components in the numerical controller 2 transfer data to each other via the bus 202.

The ROM 203 is a storage device that stores a system program or the like used for controlling the overall numerical controller 2. The ROM 203 functions as a computer readable storage medium.

The RAM 204 is a storage device that temporarily stores various data. The RAM 204 functions as a work area where the CPU 201 processes various data.

The nonvolatile memory 205 is a storage device that holds data even when the machine tool 1 is powered off and the numerical controller 2 is not supplied with power. For example, the nonvolatile memory 205 stores a machining program and stores various parameters input from the input/output device 3. The nonvolatile memory 205 functions as a computer readable storage medium. The nonvolatile memory 205 is formed of a solid state drive (SSD), for example.

The numerical controller 2 further includes an interface 206, an axis control circuit 207, a spindle control circuit 208, a programmable logic controller (PLC) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. Further, the input/output device 3 accepts input of various data and transmits the various data to the CPU 201 via the interface 206. The input/output device 3 includes a display such as a liquid crystal display (LCD), a keyboard, a mouse, and the like. Alternatively, the input/output device 3 may be a touch panel.

The axis control circuit 207 is a circuit that controls the servo motor 5. The axis control circuit 207 outputs a command for driving the servo motor 5 to the servo amplifier 4 in response to a control command from the CPU 201. For example, the axis control circuit 207 transmits a torque command used for controlling the torque of the servo motor 5 to the servo amplifier 4.

The servo amplifier 4 supplies current to the servo motor 5 in response to a command from the axis control circuit 207.

The servo motor 5 is driven in response to being supplied with current from the servo amplifier 4. For example, the servo motor 5 is coupled to a ball screw that drives a tool post, a spindle head, or a table. When the servo motor 5 is driven, a structure of the machine tool 1, such as a tool post, a spindle head, a table, or the like, moves in the X-axis direction, the Y-axis direction, or the Z-axis direction, for example. Note that a speed detector (not illustrated) that measures the feed rate of each axis may be built in the servo motor 5.

The spindle control circuit 208 is a circuit for controlling the spindle motor 7. The spindle control circuit 208 outputs a command for driving the spindle motor 7 to the spindle amplifier 6 in response to a control command from the CPU 201. For example, the spindle control circuit 208 transmits a torque command for controlling the torque of the spindle motor 7 to the spindle amplifier 6.

The spindle amplifier 6 supplies current to the spindle motor 7 in response to a command from the spindle control circuit 208. An ammeter 61 that measures a current value of current supplied to the spindle motor 7 is built in the spindle amplifier 6.

The ammeter 61 measures a current value of current supplied to the spindle motor 7. The ammeter 61 transmits data indicating a measured current value to the CPU 201.

The spindle motor 7 is driven in response to current supply from the spindle amplifier 6. The spindle motor 7 is coupled to a spindle and rotates the spindle.

The PLC 209 is a device that executes a ladder program to control the auxiliary device 8. The PLC 209 transmits a command to the auxiliary device 8 via the I/O unit 210.

The I/O unit 210 is an interface that connects the PLC 209 and the auxiliary device 8 to each other. The I/O unit 210 transmits a command received from the PLC 209 to the auxiliary device 8.

The auxiliary device 8 is installed in the machine tool 1 and performs auxiliary operations in the machine tool 1. The auxiliary device 8 may be a device installed around the machine tool 1. The auxiliary device 8 operates based on a command received from the I/O unit 210. The auxiliary device 8 is, for example, a tool changer, a cutting fluid injector, or an opening/closing door drive device.

Next, an example of functions of the numerical controller 2 will be described. The numerical controller 2 detects time-series data on a load on the spindle when a workpiece is machined at a feed rate instructed by a machining program. Furthermore, based on the detected time-series data on the load on the spindle, the numerical controller 2 predicts a load on the spindle applied when a workpiece is machined such that a machining time matches a set machining time and when the feed rate is controlled so that the load on the spindle is a constant load.

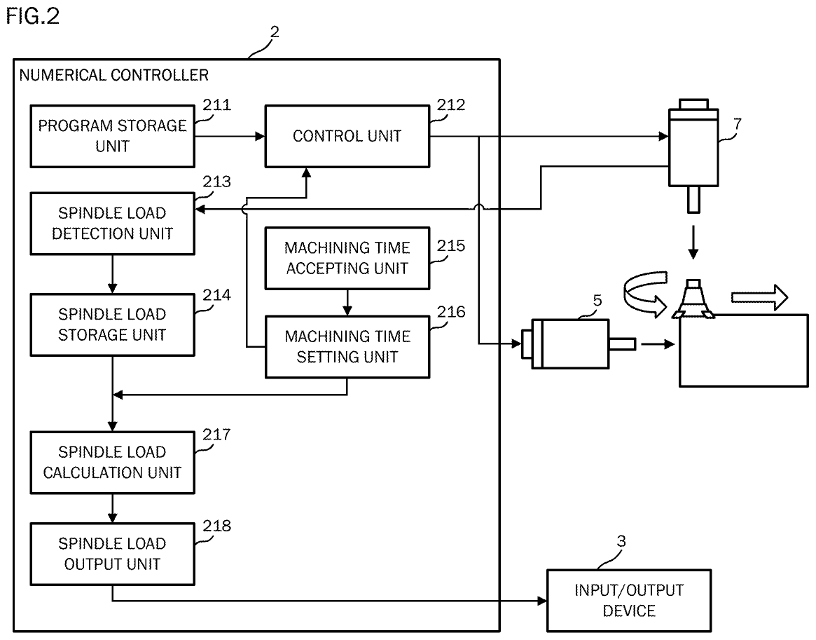

FIG. 2 is a block diagram illustrating an example of the functions of the numerical controller 2. The numerical controller 2 includes a program storage unit 211, a control unit 212, a spindle load detection unit 213, a spindle load storage unit 214, a machining time accepting unit 215, a machining time setting unit 216, a spindle load calculation unit 217, and a spindle load output unit 218.

The program storage unit 211 and the spindle load storage unit 214 are implemented when a machining program input from the input/output device 3 or the like and data input from the ammeter 61 and various sensors are stored in the RAM 204 or the nonvolatile memory 205.

The control unit 212, the spindle load detection unit 213, the machining time accepting unit 215, the machining time setting unit 216, the spindle load calculation unit 217, and the spindle load output unit 218 are implemented when the CPU 201 performs calculation processing by using a system program stored in the ROM 203 and a machining program and various data stored in the nonvolatile memory 205, for example.

The program storage unit 211 stores a machining program. The machining program is a program for operating each unit of the machine tool 1 to perform machining of a workpiece. In the machining program, a moving path of a tool, a feed rate of a tool, a rotation speed of the spindle, and the like are instructed using a G code, an M code, and the like.

The control unit 212 controls each unit of the machine tool 1 based on the machining program. For example, the control unit 212 controls the servo motor 5 and the spindle motor 7.

The control unit 212 performs constant-speed control based on a machining program. The constant-speed control is control to move a spindle at a feed rate specified by a machining program.

Further, the control unit 212 performs constant-load control based on a machining program. The constant-load control is control to change the feed rate of a spindle specified by a machining program so that the load on the spindle is a constant load. In the constant-load control, variation in the load on the spindle can be more suppressed than in the constant-speed control.

The spindle load detection unit 213 detects time-series data on the load on the spindle when a workpiece is machined based on a machining program. Further, the spindle load detection unit 213 detects time-series data indicating the feed rate of the spindle. That is, the spindle load detection unit 213 detects the load on the spindle and the feed rate of the spindle at each predetermined period while a workpiece is being machined based on the machining program.

For example, the spindle load detection unit 213 detects the load on the spindle based on a current value indicated by the ammeter 61 built in the spindle amplifier 6. Further, the spindle load detection unit 213 detects the feed rate of the spindle based on data detected by the speed detector built in the servo motor 5. Note that the load on a spindle is load torque applied in the opposite direction to the rotation direction of the spindle.

The spindle load storage unit 214 stores time-series data on the load on the spindle detected by the spindle load detection unit 213. That is, the spindle load storage unit 214 stores time-series data indicating the load on the spindle when a workpiece is machined. Further, the spindle load storage unit 214 stores time-series data indicating the feed rate of the spindle when a workpiece is machined. The time-series data stored in the spindle load storage unit 214 is time-series data detected when the constant-speed control on the spindle is performed based on a machining program.

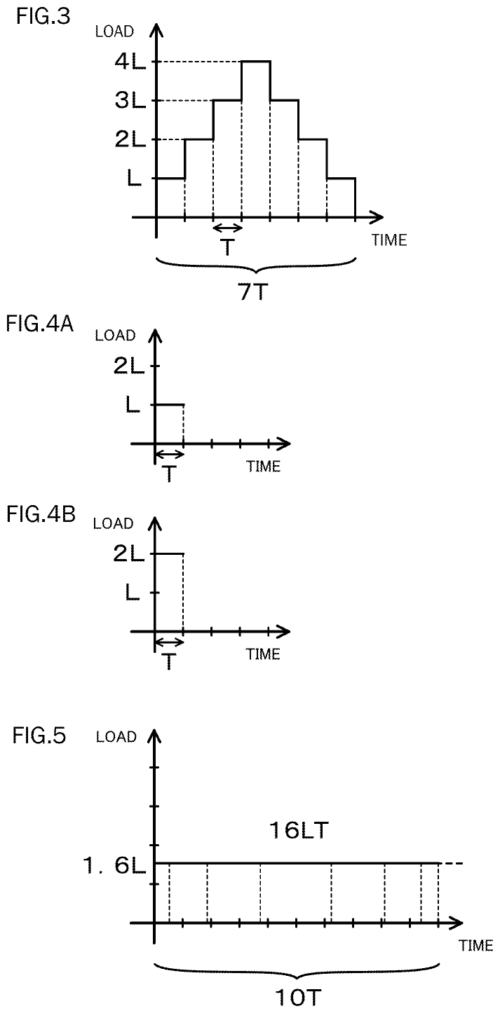

FIG. 3 is a diagram illustrating an example of the time-series data stored in the spindle load storage unit 214. That is, the time-series data illustrated in FIG. 3 is data detected when machining was performed under the constant-speed control. FIG. 3 illustrates that the spindle load storage unit 214 sequentially stores time-series data L, 2L, 3L, 4L, 3L, 2L, and L indicating the load detected at each predetermined period T.

Now, turning back to the description of FIG. 2.

The machining time accepting unit 215 accepts input of a machining time taken for machining when a machining program is executed under the constant-load control. For example, the machining time accepting unit 215 accepts a value input by an operator using the input/output device 3. The operator inputs a desired machining time taken when a workpiece is machined based on the machining program.

The machining time setting unit 216 sets a machining time accepted by the machining time accepting unit 215. That is, the machining time setting unit 216 sets a machining time taken in machining a workpiece. For example, the machining time setting unit 216 sets a machining time by storing data indicating a machining time in a predefined register (not illustrated).

Based on time-series data stored in the spindle load storage unit 214, the spindle load calculation unit 217 calculates a load on the spindle applied when a workpiece is machined in a machining time set by the machining time setting unit 216 and when the feed rate of the spindle is controlled so that the load on the spindle is a constant load. In other words, based on time-series data detected when the constant-speed control is performed, the spindle load calculation unit 217 predicts a load on the spindle applied when the machining program is executed under the constant-load control for a machining time set by the machining time setting unit 216. The spindle load calculation unit 217 calculates a load on the spindle assuming that the load on the spindle and the feed rate of the spindle are proportional to each other.

FIG. 4A, FIG. 4B, and FIG. 5 are diagrams illustrating a method of calculating a load on the spindle performed by the spindle load calculation unit 217. The spindle load calculation unit 217 first reads time-series data on the load on the spindle stored in the spindle load storage unit 214. The time-series data indicating the load on the spindle is data detected for each predetermined period T.

Next, the spindle load calculation unit 217 multiplies the value T indicating the length of a predetermined period by a value indicating the load on the spindle. For example, when the load illustrated in FIG. 3 is detected during execution of the machining program, the load detected in the first period is L. Therefore, the value obtained by multiplying the value T indicating the length of the predetermined period by the value L indicating the load on the spindle is LT (see FIG. 4A). Further, the load on the spindle detected in the next period is 2L. Therefore, the value obtained by multiplying the value T indicating the predetermined period by the value 2L indicating the load on the spindle is 2LT (see FIG. 4B). Similarly, values calculated for the third and subsequent periods will be 3LT, 4LT, 3LT, 2LT, and LT, respectively.

Next, the spindle load calculation unit 217 sums up respective values calculated by multiplying the value T indicating the length of a predetermined period by respective values indicating the load on the spindle. In the example illustrated in FIG. 3, the total value is 16LT.

Next, the spindle load calculation unit 217 calculates a load on the spindle by dividing the total value, which is calculated by summing up respective values, by a value indicating a machining time set by the machining time setting unit 216. For example, when the total value is 16LT and the machining time set by the machining time setting unit 216 is 10T, the load on the spindle will be 1.6L (see FIG. 5). Accordingly, the spindle load calculation unit 217 can calculate the load on the spindle of 1.6L when it is assumed that the load on the spindle and the feed rate of the spindle are proportional to each other. Note that the spindle load calculation unit 217 may further calculate a feed rate of the spindle applied when a workpiece is machined in a machining time set by the machining time setting unit 216 and when the feed control is performed on the spindle so that the load on the spindle is a constant load.

The spindle load output unit 218 outputs data indicating a load on the spindle calculated by the spindle load calculation unit 217. The spindle load output unit 218 outputs data indicating the calculated load on the spindle and data indicating a machining time set by the machining time setting unit 216 to the input/output device 3, for example, and displays the load on the spindle and the machining time on the input/output device 3. The spindle load output unit 218 may output a feed rate of the spindle calculated in the process in which the spindle load calculation unit 217 calculates the load on the spindle. In such a case, the spindle load output unit 218 may output data indicating the feed rate of the spindle such that the feed rates of the spindle for respective periods are graphically displayed.

Next, a flow of the process performed by the numerical controller 2 will be described.

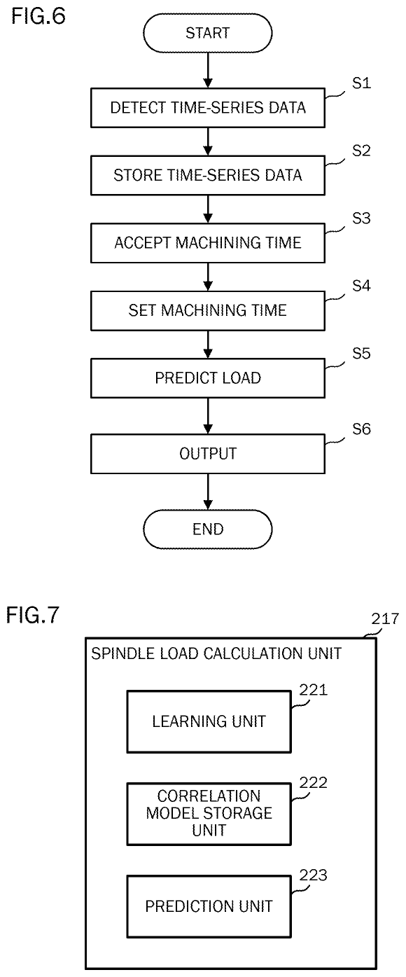

FIG. 6 is a flowchart illustrating an example of a flow of the process performed by the numerical controller 2. First, the spindle load detection unit 213 detects time-series data indicating a load on the spindle when a workpiece is machined under the constant-speed control based on a machining program (step S1).

Next, the spindle load storage unit 214 stores the time-series data indicating the load on the spindle detected by the spindle load detection unit 213 (step S2).

Next, the machining time accepting unit 215 accepts input of a value indicating a machining time taken when a workpiece is machined under the constant-load control based on the machining program (step S3).

Next, the machining time setting unit 216 sets the value accepted by the machining time accepting unit 215 as a machining time (step S4).

Next, the spindle load calculation unit 217 calculates the load on the spindle applied when the machining program is executed for the machining time set by the machining time setting unit 216 (step S5).

Finally, the spindle load output unit 218 outputs data indicating the load on the spindle calculated by the spindle load calculation unit 217 (step S6) and ends the process.

Because the numerical controller 2 performs such a process, a load on the spindle applied when a machining program is executed based on the constant-load control so that a workpiece is machined in a machining time set by the machining time setting unit 216 can be displayed on the input/output device 3, for example. Further, the control unit 212 can perform machining of a workpiece in a machining time set by the machining time setting unit 216.

As described above, the numerical controller 2 includes the spindle load detection unit 213 that detects time-series data on a load on a spindle when a workpiece is machined, the machining time setting unit 216 that sets a machining time taken in machining the workpiece, the spindle load calculation unit 217 that, based on the time-series data, calculates the load on the spindle applied when the workpiece is machined in the machining time set by the machining time setting unit 216 and when a feed rate of the spindle is controlled so that the load on the spindle is a constant load, and the spindle load output unit 218 that outputs data indicating the load on the spindle calculated by the spindle load calculation unit 217. Accordingly, when the feed rate of the spindle is controlled so that the load on the spindle remains constant, the numerical controller 2 makes it possible to set a machining time for a workpiece to a desired time.

Further, the numerical controller 2 further includes a machining time accepting unit 215 that accepts input of a value indicating a machining time set by the machining time setting unit 216. Thus, the numerical controller 2 can predict a machining time in accordance with an input target load. Further, since the numerical controller 2 outputs a value indicating a load on the spindle, the operator is able to set a machining time taking the balance between a load on the spindle and a machining time into consideration.

Further, the spindle load calculation unit 217 calculates a load on the spindle assuming that the load on the spindle and the feed rate are proportional to each other. Thus, the spindle load calculation unit 217 can calculate a load on the spindle without performing complex calculation.

Further, the spindle load calculation unit 217 further calculates a feed rate of the spindle applied when a workpiece is machined in a machining time set by the machining time setting unit 216 and when the feed rate of the spindle is controlled so that the load on the spindle is a constant load. This enables the operator to determine whether or not the feed rate of the spindle is a speed suitable for machining of the workpiece and then set a machining time.

Further, the numerical controller 2 further includes the spindle load storage unit 214 that stores time-series data detected by the spindle load detection unit 213. This enables the spindle load calculation unit 217 to calculate the load on the spindle for various machining times based on the time-series data stored in the spindle load storage unit 214.

In the embodiment described above, the spindle load calculation unit 217 calculates a load on the spindle assuming that the load on the spindle and the feed rate of the spindle are proportional to each other. However, the spindle load calculation unit 217 may predict a load on the spindle based on a correlation model indicating the relationship between the load on the spindle and the feed rate of the spindle.

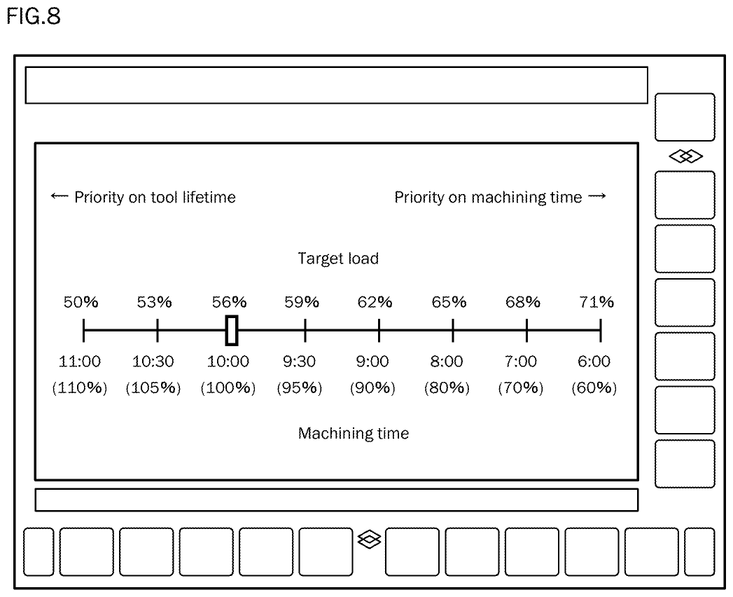

FIG. 7 is a diagram illustrating an example of the spindle load calculation unit 217 that calculates a load on the spindle based on a correlation model. The spindle load calculation unit 217 includes a learning unit 221, a correlation model storage unit 222, and a prediction unit 223. Note that the configuration except for the spindle load calculation unit 217 is the same as the configuration of the embodiment described above.

The learning unit 221 generates a correlation model indicating the relationship between a load on the spindle and a feed rate of the spindle based on time-series data indicating the load on the spindle and time-series data indicating the feed rate of the spindle stored in the spindle load storage unit 214. The learning unit 221 generates a correlation model by using a regression equation, a support vector machine (SVM), or a neural network, for example.

The correlation model storage unit 222 stores a correlation model generated by the learning unit 221.

The prediction unit 223 uses a correlation model stored in the correlation model storage unit 222 to calculate a load on the spindle applied when machining is performed such that machining performed based on a machining program is completed in a machining time set by the machining time setting unit 216. Further, a feed rate of the spindle when machining is performed such that the machining performed based on the machining program is completed in the machining time set by the machining time setting unit 216 may be calculated.

The data indicating the load on the spindle predicted by the prediction unit 223 is output by the spindle load output unit 218.

In the embodiment described above, the numerical controller 2 further includes the learning unit 221 that learns the relationship between the load on the spindle and the feed rate, and the spindle load calculation unit 217 calculates the load on the spindle based on the relationship learned by the learning unit 221. Therefore, the spindle load calculation unit 217 can predict the load on the spindle with high accuracy.

Further, although the numerical controller 2 of the embodiment described above includes the machining time accepting unit 215, the numerical controller 2 does not necessarily need to include the machining time accepting unit 215. In such a case, the numerical controller 2 stores values indicating a plurality of machining times in advance and predicts a load on the spindle applied when the feed rate of the spindle is controlled so that execution of the machining program is completed in each machining time.

FIG. 8 is a diagram illustrating a display example of the load on the spindle displayed on the input/output device 3 when the numerical controller 2 stores a plurality of values indicating machining times. For example, machining times set in advance are stored in the numerical controller 2. In the example illustrated in FIG. 8, 11:00, 10:30, 10:00, 9:30, 9:00, 8:00, 7:00, and 6:00 are stored as the machining times.

The spindle load calculation unit 217 calculates a load on the spindle applied when the constant-load control is performed so that machining of a workpiece is completed in these machining times. The data indicating the load calculated by the spindle load calculation unit 217 is output by the spindle load output unit 218 and displayed on a display screen of the input/output device 3.

For example, a straight line extending laterally with scales is displayed on the display screen. On the underside of the straight line, set machining times are displayed. On the upper side of the straight line, values indicating ratios of target torque to rated torque are displayed as the calculated load on the spindle.

In the example illustrated in FIG. 8, load 50% is displayed in association with the set machining time 11:00. Further, load 53% is displayed in association with the set machining time 10:30. Further, load 56% is displayed in association with the set machining time 10:00. Further, load 59% is displayed in association with the set machining time 9:30. Further, load 62% is displayed in association with the set machining time 9:00. Further, load 65% is displayed in association with the set machining time 8:00. Further, load 68% is displayed in association with the set machining time 7:00. Further, load 71% is displayed in association with the set machining time 6:00.

Display of the machining time and the load on the spindle in such a manner enables the operator to easily recognize the load on the spindle applied when the constant-load control is performed so that a workpiece is machined in each machining time.

Note that the set machining times may be displayed under the region where respective machining times are displayed as ratios to machining times taken when a workpiece is machined under the constant-speed control. For example, in the example illustrated in FIG. 8, the machining time is 10:00 when the constant-speed control is performed, and respective set machining times are displayed in parentheses as ratios to 10:00.

Further, as illustrated in FIG. 8, when set machining times and loads on the spindle are arranged as pairs, respectively, and displayed on the input/output device 3, any one of the machining times may be selected on the display screen. In such a case, the control unit 212 may execute the machining program under the constant-load control so that a workpiece is machined in a selected machining time.

In the embodiment described above, the numerical controller 2 includes the spindle load storage unit 214. However, the numerical controller 2 is not necessarily required to include the spindle load storage unit 214.

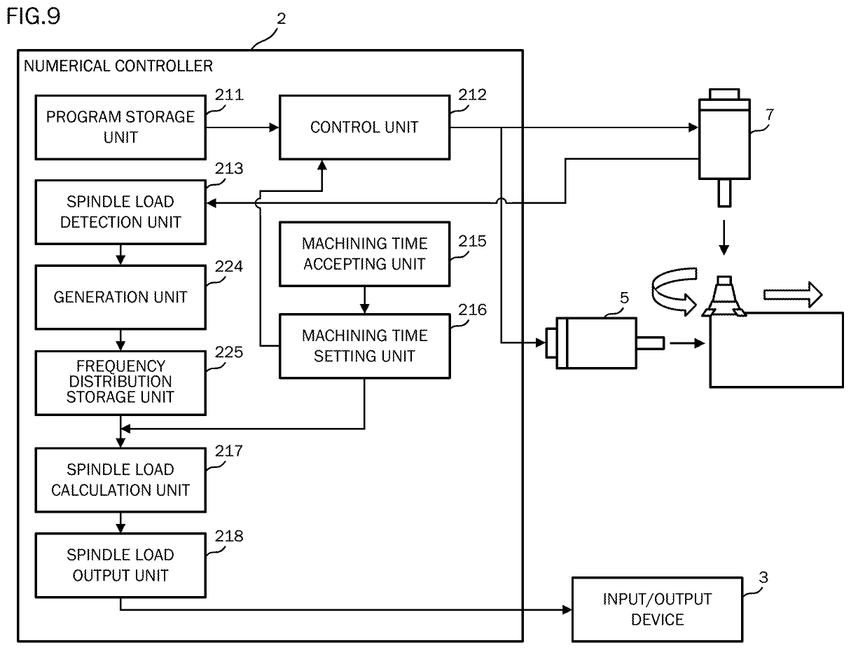

FIG. 9 is a block diagram illustrating an example of functions of the numerical controller 2. The numerical controller 2 includes a generation unit 224 and a frequency distribution storage unit 225 instead of the spindle load storage unit 214. The rest of the configuration is the same as the configuration of the numerical controller 2 illustrated in FIG. 2.

For example, the generation unit 224 is implemented when the CPU 201 performs calculation processing by using a system program stored in the ROM 203 and a machining program and various data stored in the nonvolatile memory 205. For example, the frequency distribution storage unit 225 is implemented when data generated by the CPU 201 performing calculation processing by using a system program and various data is stored in the RAM 204 or the nonvolatile memory 205.

The generation unit 224 generates frequency distribution data based on the time-series data detected by the spindle load detection unit 213.

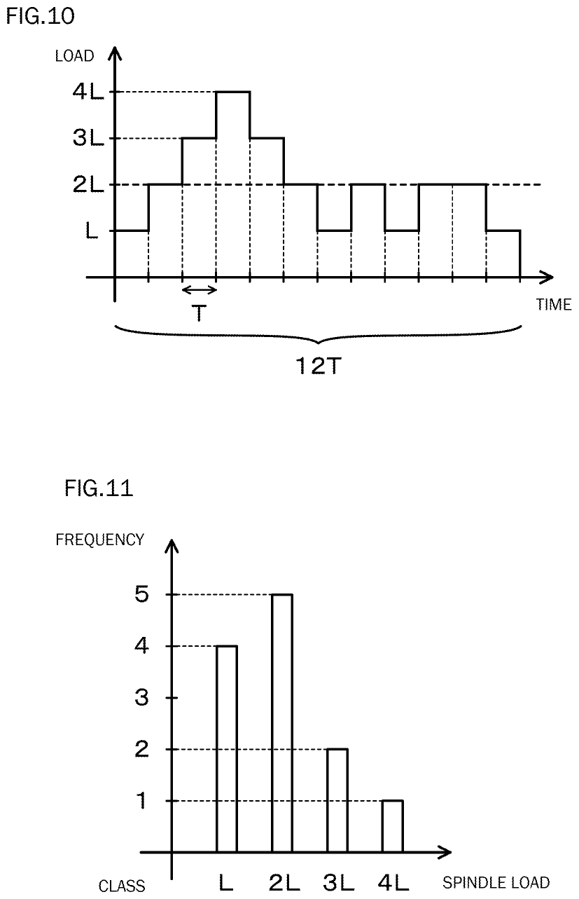

FIG. 10 is a diagram illustrating time-series data detected by the spindle load detection unit 213. That is, the time-series data illustrated in FIG. 10 is data detected when machining is performed under the constant-speed control. FIG. 11 is a diagram illustrating an example of a frequency distribution. The generation unit 224 classifies loads on the spindle detected by the spindle load detection unit 213 into a plurality of classes and counts the frequency for each class. For example, the generation unit 224 classifies the detected loads into any one of four classes L, 2L, 3L, and 4L. For example, the generation unit 224 rounds off values of loads detected by the spindle load detection unit 213 to classify the values into any one of L, 2L, 3L, and 4L.

For example, the generation unit 224 classifies a load having a level that is greater than or equal to 0.5L and less than 1.5L into the class L. Similarly, a load having a level that is greater than or equal to 1.5L and less than 2.5L is classified into the class 2L. Further, a load having a level that is greater than or equal to 2.5L and less than 3.5L is classified into the class 3L. Further, a load having a level that is greater than or equal to 3.5L and less than 4.5L is classified into the class 4L. In the example illustrated in FIG. 11, four values are classified into the class L, five values are classified into the class 2L, two values are classified into the class 3L, and one value is classified into the class 4L.

The frequency distribution storage unit 225 stores frequency distribution data generated by the generation unit 224.

The spindle load calculation unit 217 calculates a load on the spindle applied when a workpiece is machined in the machining time set based on the frequency distribution data stored in the frequency distribution storage unit 225. First, the spindle load calculation unit 217 sums up values of “value of class”×“frequency”×“period” where each of the values is obtained by multiplying the value of each class by the frequency for each class by a period in which a load on the spindle is detected. For example, in the example illustrated in FIG. 11, L×4×T+2L×5×T+3L×2×T+4L×4×T=24LT is found.

Next, the spindle load calculation unit 217 divides the found total value by the machining time set by the machining time setting unit 216. For example, when the found total value is 24LT and the machining time set by the machining time setting unit 216 is 10T, the load on the spindle is calculated to 2.4L.

In the embodiment described above, the numerical controller 2 further includes the frequency distribution storage unit 225 that stores data indicating a frequency distribution generated based on the time-series data detected by the spindle load detection unit 213. Therefore, the amount of data to be stored can be reduced compared to a case where the spindle load storage unit 214 stores time-series data. Thus, the amount of data stored in the memory can be reduced.

### LIST OF REFERENCE SYMBOLS

1 machine tool
2 numerical controller
201 CPU
202 bus
203 ROM
204 RAM
205 nonvolatile memory
206 interface
207 axis control circuit
208 spindle control circuit
209 PLC
210 I/O unit
211 program storage unit
212 control unit
213 spindle load detection unit
214 spindle load storage unit
215 machining time accepting unit
216 machining time setting unit
217 spindle load calculation unit
218 spindle load output unit
221 learning unit
222 correlation model storage unit
223 prediction unit
224 generation unit
225 frequency distribution storage unit
3 input/output device
4 servo amplifier
5 servo motor
6 spindle amplifier
61 ammeter
7 spindle motor
8 auxiliary device

1. A numerical controller comprising:
a spindle load detection unit that detects time-series data on a load on a spindle when a workpiece is machined;
a machining time setting unit that sets a machining time taken in machining the workpiece;
a spindle load calculation unit that, based on the time-series data, calculates a load on the spindle applied when the workpiece is machined in the machining time set by the machining time setting unit and when a feed rate of the spindle is controlled so that the load on the spindle is a constant load; and
a spindle load output unit that outputs data indicating the load on the spindle calculated by the spindle load calculation unit.

2. The numerical controller according to claim 1 further comprising a machining time accepting unit that accepts input of a value indicating the machining time set by the machining time setting unit.

3. The numerical controller according to claim 1, wherein the spindle load calculation unit calculates the load on the spindle assuming that the load on the spindle and the feed rate are proportional to each other.

4. The numerical controller according to claim 1 further comprising a learning unit that learns a relationship between the load on the spindle and the feed rate,
wherein the spindle load calculation unit calculates the load on the spindle based on the relationship learned by the learning unit.

5. The numerical controller according to claim 1, wherein the spindle load output unit further outputs data indicating a relationship between the machining time set by the machining time setting unit and the load on the spindle.

6. The numerical controller according to claim 1, wherein the spindle load calculation unit further calculates a feed rate applied when the workpiece is machined in the machining time set by the machining time setting unit and when the feed rate of the spindle is controlled so that the load on the spindle is a constant load.

7. The numerical controller according to claim 1 further comprising a spindle load storage unit that stores the time-series data detected by the spindle load detection unit.

8. The numerical controller according to claim 1 further comprising a frequency distribution storage unit that stores frequency distribution data generated based on the time-series data detected by the spindle load detection unit.

9. A computer readable storage medium storing an instruction that causes a computer to perform:
detecting time-series data on a load on a spindle when a workpiece is machined;
setting a machining time taken in machining the workpiece;
based on the time-series data, calculating a load on the spindle applied when the workpiece is machined in the set machining time and when a feed rate of the spindle is controlled so that the load on the spindle is a constant load; and
outputting data indicating the calculated load on the spindle.
